(19) United States
(12) Patent Application Publication
(10) Pub. No.: US 2023/0267432 A1
(43) Pub. Date: Aug. 24, 2023

(54) IMAGE PROCESSING APPARATUS THAT SETS INFORMATION RELATED TO TRANSFER DESTINATION, METHOD OF CONTROLLING IMAGE PROCESSING APPARATUS, AND STORAGE MEDIUM

(71) Applicant: CANON KABUSHIKI KAISHA, Tokyo (JP)

(72) Inventor: YASUNORI SHIMAKAWA, Chiba (JP)

(21) Appl. No.: 18/166,536

(22) Filed: Feb. 9, 2023

(30) Foreign Application Priority Data
Feb. 21, 2022 (JP) 2022-024736

(51) Int. Cl. G06Q 20/10; H04N 1/00; H04N 1/32; H04N 1/44

(52) U.S. Cl. CPC G06Q 20/108; H04N 1/00331; H04N 1/00244; H04N 1/00214; H04N 1/00241; H04N 1/32358; H04N 1/32101; H04N 1/4413; H04N 2201/3204; H04N 2201/3273; H04N 2201/0094; H04N 1/00212

(57) ABSTRACT

An image processing apparatus capable of reducing time and labor of a user required to set information on a transfer destination. The image processing apparatus communicates with a server which provides a transfer service. An original on which a transfer destination is written is read to generate image data of the original. Optical character recognition is performed on the image data to extract a number having a predetermined number of digits. The number and position information of the number in the image data are stored. Information on the transfer destination, included in the image data, is acquired based on the number and the position information of the number. Control is performed to transmit a transfer instruction notification including the information on the transfer destination to the server.

### BACKGROUND OF THE INVENTION

### Field of the Invention

The present invention relates to an image processing apparatus that sets information on a transfer destination, a method of controlling the image processing apparatus, and a storage medium.

### Description of the Related Art

There is known an image processing apparatus that reads an original, generates image data of the read original, and performs optical character recognition on the image data. For example, the image processing apparatus reads a bill on which a transfer destination is written, generates image data of the read bill, and displays character data recognized by performing optical character recognition on the image data on a console section of the image processing apparatus. A user designates information on the transfer destination, such as a financial institution name, a branch office name, an account type, and an account number, from the displayed character data. In a case where the designated information matches information registered in a financial institution information database in advance, transfer processing is executed using the designated information (see e.g. Japanese Laid-Open Patent Publication (Kokai) No. 2013-109726). With this, the user can cause the image processing apparatus to execute the transfer processing without inputting the information on the transfer destination.

However, in the above-described technique disclosed in Japanese Laid-Open Patent Publication (Kokai) No. 2013-109726, even when the user executes transfer processing to the same transfer destination, the user is required to cause the image processing apparatus to read a bill and designate the information on the transfer destination from character data displayed on the console section of the image processing apparatus whenever the user executes transfer processing, which imposes time and labor on the user.

### SUMMARY OF THE INVENTION

The present invention provides an image processing apparatus that is capable of reducing time and labor of a user required to set information on a transfer destination, a method of controlling the image processing apparatus, and a storage medium.

In a first aspect of the present invention, there is provided an image processing apparatus that communicates with a server which provides a transfer service, including at least one processor, and a memory coupled to the at least one processor, the memory having instructions that, when executed by the processor, perform the operations as: a reading unit configured to read an original on which a transfer destination is written and generate image data of the original, an extraction unit configured to extract a number having a predetermined number of digits by performing optical character recognition on the image data, a storage unit configured to store the number and position information of the number in the image data, an acquisition unit configured to acquire information on the transfer destination, which is included in the image data, based on the number and the position information of the number, and a transmission control unit configured to perform control to transmit a transfer instruction notification including the information on the transfer destination to the server.

In a second aspect of the present invention, there is provided a method of controlling an image processing apparatus that communicates with a server which provides a transfer service, including reading an original on which a transfer destination is written and generating image data of the original, extracting a number having a predetermined number of digits by performing optical character recognition on the image data, storing the number and position information of the number in the image data, acquiring information on the transfer destination, which is included in the image data, based on the number and the position information of the number, and performing control to transmit a transfer instruction notification including the information on the transfer destination to the server.

According to the present invention, it is possible to reduce time and labor of a user required to set information on a transfer destination.

Further features of the present invention will become apparent from the following description of exemplary embodiments (with reference to the attached drawings).

### BRIEF DESCRIPTION OF THE DRAWINGS

FIG. 1 is a network configuration diagram of a system including an image forming apparatus as an image processing apparatus according to the present embodiment.

FIG. 2 is a schematic block diagram of the image forming apparatus appearing in FIG. 1.

FIG. 3 is a diagram showing an example of a home screen displayed on a console section appearing in FIG. 2.

FIG. 4 is a sequence diagram of a transfer source user information registration process in the present embodiment.

FIGS. 5A and 5B are diagrams each showing an example of a registration screen displayed on the console section appearing in FIG. 2.

FIG. 6 is a diagram showing an example of a setting screen displayed on the console section appearing in FIG. 2.

FIG. 7 is a diagram showing an example of the home screen displayed on the console section appearing in FIG. 2.

FIG. 8 is a diagram showing an example of an authentication failure screen displayed on the console section appearing in FIG. 2.

FIGS. 9A to 9C are diagrams each showing an example of a registration screen displayed on a display section of a PC appearing in FIG. 1.

FIG. 10 is a flowchart of a transfer destination registration process performed by the image forming apparatus appearing in FIG. 1.

FIGS. 11A to 11C are diagrams each showing an example of a confirmation screen displayed on the console section appearing in FIG. 2.

FIG. 12 is a diagram showing an example of an abortion screen displayed on the console section appearing in FIG. 2.

FIG. 13 is a diagram showing an example of a transfer destination confirmation screen displayed on the console section appearing in FIG. 2.

FIG. 14 is a diagram showing an example of a processing failure screen displayed on the console section appearing in FIG. 2.

FIG. 15 is a diagram showing an example of a transfer amount selection screen displayed on the console section appearing in FIG. 2.

FIGS. 16A and 16B are diagrams each showing an example of an error screen displayed on the console section appearing in FIG. 2.

FIGS. 17A and 17B are diagrams showing examples of a transfer destination information registration screen and a registered name-setting screen, displayed on the console section appearing in FIG. 2, respectively.

FIG. 18 is a diagram showing an example of a transfer information management screen displayed on the console section appearing in FIG. 2.

FIG. 19 is a flowchart of a transfer destination information-storing process in a step in FIG. 10.

FIG. 20 is a diagram showing a first example of a bill.

FIG. 21 is a diagram showing a second example of the bill.

FIG. 22 is a diagram showing a third example of the bill.

FIG. 23 is a diagram showing a fourth example of the bill.

FIG. 24 is a sequence diagram of a transfer process as a banking service in the present embodiment.

FIGS. 25A and 25B are diagrams each showing an example of a transfer confirmation screen displayed on the console section appearing in FIG. 2.

FIG. 26 is a flowchart of a transfer control process performed by the image forming apparatus appearing in FIG. 1.

FIG. 27 is a diagram showing an example of the home screen displayed on the console section appearing in FIG. 2.

### DESCRIPTION OF THE EMBODIMENTS

The present invention will now be described in detail below with reference to the accompanying drawings showing embodiments thereof. Note that the embodiments described below are by no means intended to limit the scope of the present invention as recited in the appended claims, but not all combinations of features described in the embodiments are absolutely essential to the solution of the invention.

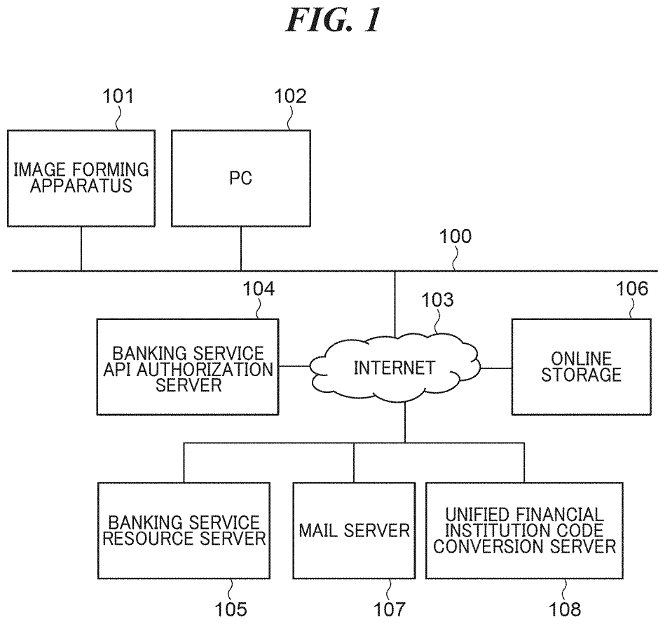

FIG. 1 is a network configuration diagram of a system including an image forming apparatus 101 as an image processing apparatus according to the present embodiment.

The image forming apparatus 101 is an example of the image processing apparatus and is e.g. a multi-function peripheral (MFP). The image forming apparatus 101 can communicate with a personal computer (PC) 102 via a network 100. The network 100 is connected to the Internet 103. The PC 102 is used to acquire and display a status of the image forming apparatus 101, configure settings of the image forming apparatus 101, and transmit print data to the image forming apparatus 101.

To the Internet 103, a banking service API authorization server 104, a banking service resource server 105, an online storage 106, an e-mail server 107, and a unified financial institution code conversion server 108 are connected. API is the initials of Application Programming Interface. The banking service API authorization server 104 authorizes the use of a banking service API. The banking service resource server 105 provides banking services, such as a transfer service and an account activity statement delivery service. The online storage 106 stores images, configuration information, and so forth. The mail server 107 transmits and receives e-mails. The unified financial institution code conversion server 108 converts a bank name and a branch office name to a unified financial institution code and a branch code, respectively corresponding thereto.

The image forming apparatus 101, the PC 102, the banking service API authorization server 104, the banking service resource server 105, the online storage 106, and the mail server 107 can communicate with one another. The image forming apparatus 101 reads an original, generates image data of the read original, and transmits the image data to the PC 102 and the online storage 106. Further, the image forming apparatus 101 reads an original, generates image data of the read original, and transmits the image data to the mail server 107 as an attachment to an e-mail. Furthermore, the image forming apparatus 101 has a function of recognizing characters from image data obtained by reading an original and outputting character data. The PC 102 can set or update settings of the image forming apparatus 101 by using an HTTP protocol.

Note that in the present embodiment, the network 100 may be configured such that the image forming apparatus 101 is wirelessly connected to an access point (not shown) of the network 100 insofar as image data can be transmitted. Further, the image data in the present embodiment is electronic data. The image data is not limited to electronic data which is RAW data generated from an image but may be electronic data in an image format, such as TIFF or JPEG, or electronic data in PDF format.

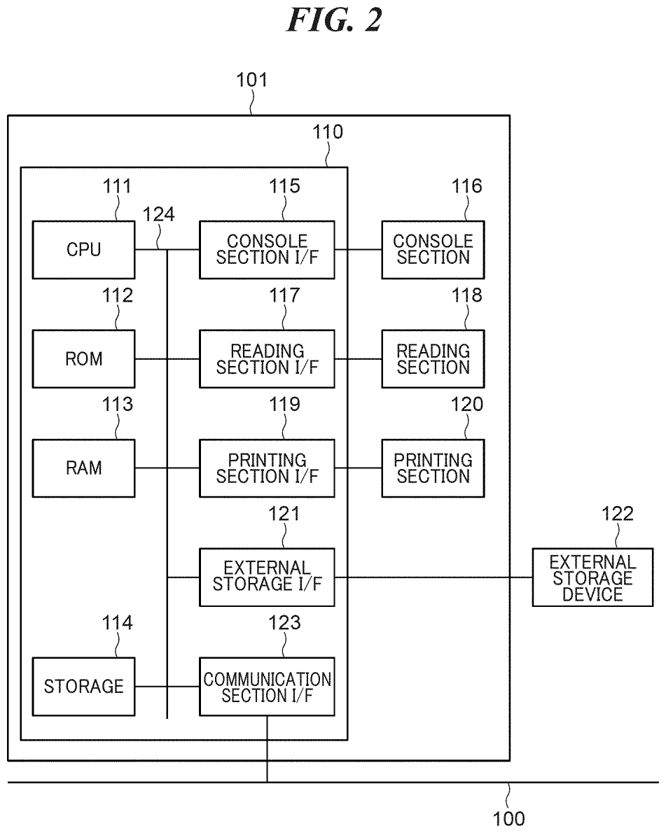

FIG. 2 is a schematic block diagram of the image forming apparatus 101 appearing in FIG. 1. Referring to FIG. 2, the image forming apparatus 101 includes a controller 110, a console section 116, a reading section 118, and a printing section 120. The controller 110 is connected to the console section 116, the reading section 118, and the printing section 120. Further, the controller 110 includes a CPU 111, a ROM 112, a RAM 113, a storage 114, a console section interface (I/F) 115, a reading section interface 117, a printing section interface 119, an external storage interface 121, and a communication section interface 123. These components are interconnected via a system bus 124. Note that CPU is an abbreviation of Central Processing Unit. ROM is an abbreviation of Read Only Memory. RAM is an abbreviation of Random Access Memory.

The CPU 111 controls the operation of the image forming apparatus 101. The CPU 111 loads a program stored in the ROM 112 or the storage 114 into the RAM 113 and executes the loaded program. The program is e.g. a control program, and the CPU 111 performs a variety of controls, such as reading control or printing control by executing the control program. The ROM 112 stores programs to be executed by the CPU 111. Further, the ROM 112 stores a boot program, font data, and so forth. The RAM 113 is a main storage memory for the CPU 111. The RAM 113 is used as a work area for the CPU 111 and is further used as a temporary storage area for loading a program stored in the ROM 112 or the storage 114. Further, the RAM 113 is also used to temporarily store image data.

The storage 114 stores image data, print data, an address book, short cuts, a variety of programs, and a variety of configuration information. Although in the present embodiment, it is assumed that a flash memory is used as the storage 114, an auxiliary storage device, such as an SSD, an HDD, or an eMMC, may be used. Note that SSD is an abbreviation of Solid State Drive. HDD is an abbreviation of Hard Disk Drive. The term eMMC is an abbreviation of embedded Multi Media Card.

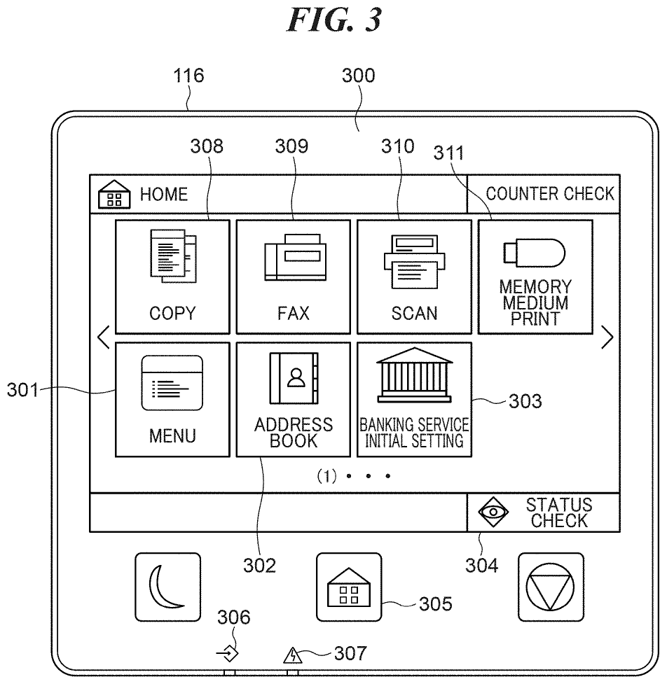

The console section interface 115 is an interface for connecting the console section 116 to the controller 110. As shown in FIG. 3, the console section 116 is comprised of a touch panel 300, a home key 305, a data LED 306, and an error LED 307. The touch panel 300 is formed by affixing a touch panel sheet onto a display. The home key 305 is a hard key which is a button for switching a screen being displayed to a home screen. The data LED 306 is lighted during transmission of data to thereby notify a user that the image forming apparatus 101 is transmitting data. The error LED 307 is lighted when an error occurs in the image forming apparatus 101. The console section 116 receives a user's operation on the hard key or each of a variety of objects displayed on the console section 116 and displays a screen associated with the user's operation via the touch panel 300.

The reading section interface 117 is for connecting the reading section 118 to the controller 110. The reading section 118 reads an image of an original set thereon and generates image data of the read original. The image data generated by the reading section 118 is subjected to optical character recognition, transmitted to an external apparatus, or printed on a sheet for printing.

The printing section interface 119 is for connecting the printing section 120 to the controller 110. The CPU 111 transfers image data to be printed to the printing section 120 via the printing section interface 119. The printing section 120 prints an image on a sheet fed from a sheet feed cassette based on the acquired image data. Note that as the method of printing an image, there may be used any of the electrophotographic method for printing an image using toner and the inkjet method for printing an image using ink.

The external storage interface 121 is for connecting an external storage device 122 to the controller 110. The CPU 111 stores image data in the external storage device 122 via the external storage interface 121. Note that although in the present embodiment, it is assumed that a USB interface is used as the external storage interface 121, and a USB memory is used as the external storage device 122, this is not limitative. For example, as the external storage device 122, there may be used an SD card or the like. SD is an abbreviation of Secure Digital.

The controller 110 is connected to the network 100 via the communication section interface 123. The network 100 is e.g. a LAN. LAN is an abbreviation of Local Area Network. The communication section interface 123 controls transmission and reception of data, which are performed via the network 100. For example, the image forming apparatus 101 transmits a variety of configuration information set in the self-apparatus to the PC 102, transmits e-mails to the mail server 107, and transmits image data to the online storage 106 via the communication section interface 123. Further, the image forming apparatus 101 connects to the banking service API authorization server 104 via the communication section interface 123 to acquire an authorization code of the banking service API, which is provided by the banking service resource server 105. Further, the image forming apparatus 101 connects to the banking service resource server 105 via the communication section interface 123 to use a service provided by the banking service API by presenting the acquired authorization code of the banking service API. Registration and changing of the variety of configuration information for acquiring the authorization code of the banking service API are performed by accessing the image forming apparatus 101 from the PC 102 using the HTTP.

Note that, although not shown, the PC 102 includes a CPU, a RAM, a ROM, a storage, a communication interface, and a console section. Each of the banking service API authorization server 104, the banking service resource server 105, the online storage 106, and the mail server 107 has the same hardware.

FIG. 3 is a diagram showing an example of the home screen displayed on the console section 116 appearing in FIG. 2. The home screen is for instructing execution of a variety of functions of the image forming apparatus 101 and is displayed on the console section 116 immediately after the image forming apparatus 101 is started up. On the home screen, for example, a copy button 308, a fax button 309, a scan button 310, and a memory medium print button 311 are displayed. The copy button 308 is for using a copy function for causing the reading section 118 to read an original and generate image data of the read original, and causing the printing section 120 to perform print processing based on this image data. The fax button 309 is for using a fax function for causing the reading section 118 to read an original and generate image data of the read original, and transmitting this image data using a modem, not shown. The scan button 310 is for using a scan transmission function for causing the reading section 118 to read an original and generate image data of the read original, and transmitting this image data via the communication section interface 123. Note that the scan transmission function includes e.g. an e-mail function for transmitting image data as an attachment to an e-mail and a folder transmission function for transmitting image data to store the image data in a designated folder. The memory medium print button 311 is for causing the printing section 120 to perform print processing based on image data stored in the external storage device 122, such as a USB memory. The home screen displays not only these buttons, but also a menu button 301, an address book button 302 for calling an address book, and a banking service initial setting button 303 for registering user information of a transfer source, which is used when money is transferred by a banking service of the banking service resource server 105.

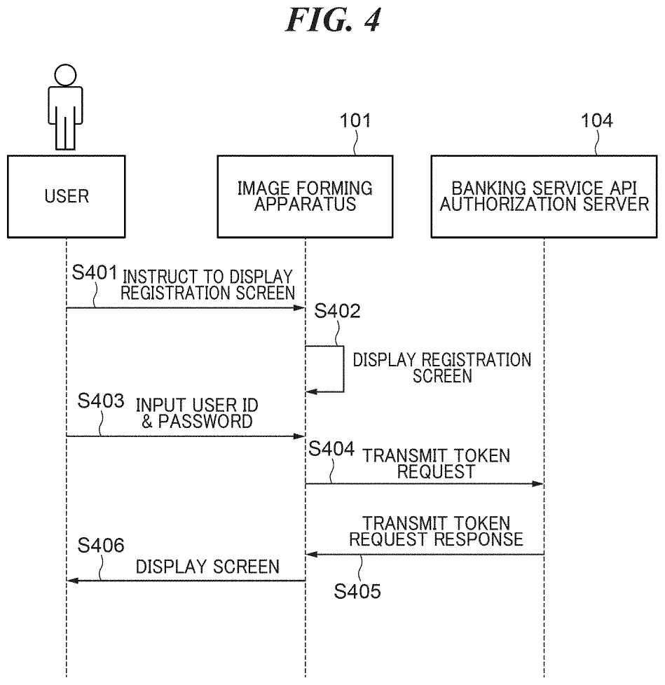

FIG. 4 is a sequence diagram of a transfer source user information registration process in the present embodiment. The transfer source user information registration process is executed by the image forming apparatus 101 and the banking service API authorization server 104.

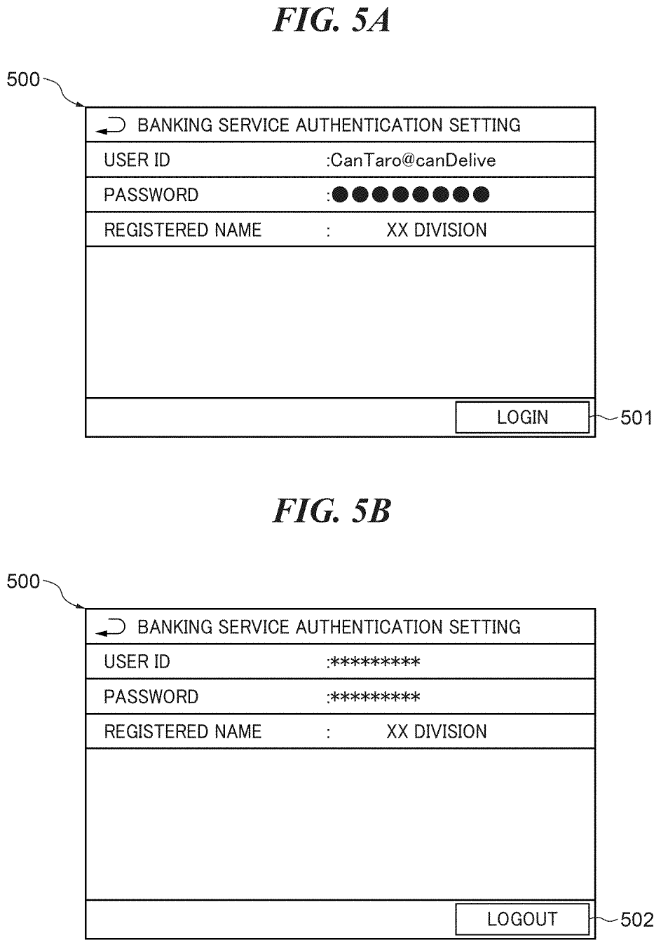

Referring to FIG. 4, first, a user operates the console section 116 of the image forming apparatus 101 to instruct the image forming apparatus 101 to display a registration screen for registering user information of a transfer source (step S401). As this display instruction, for example, the user selects the banking service initial setting button 303 or selects a registration setting button displayed on the console section 116 by selecting the menu button 301. The image forming apparatus 101 having received this display instruction displays the registration screen, denoted by reference numeral 500 (see FIG. 5A) on the console section 116 (step S402). The registration screen 500 is for registering user information of a transfer source, which is used when money is transferred by the banking service of the banking service resource server 105.

Then, the user inputs, on the registration screen 500, a user ID and a password which have been registered in the banking service API authorization server 104 in advance so as to use the banking services (step S403). At this time, on the registration screen 500, for example, as shown in FIG. 5A, although the user ID input by the user is displayed as it is, the password input by the user is displayed as turned characters (black circles in the illustrated example). Further, the user inputs a registered name of the banking service. The input user ID, password, and registered name of the banking service are stored in the storage 114 as the user information of the transfer source. When the user completes inputting of these items and selects a login button 501, the image forming apparatus 101 transmits a token request including the user ID and the password, input by the user, to the banking service API authorization server 104 (step S404).

The banking service API authorization server 104 performs authentication processing for determining whether or not the user ID and the password, included in the received token request, match information registered in advance. The banking service API authorization server 104 transmits a token request response indicating a success or a failure of the authentication to the image forming apparatus 101 (step S405). The image forming apparatus 101 displays a screen on the console section 116 based on the received token request response (step S406).

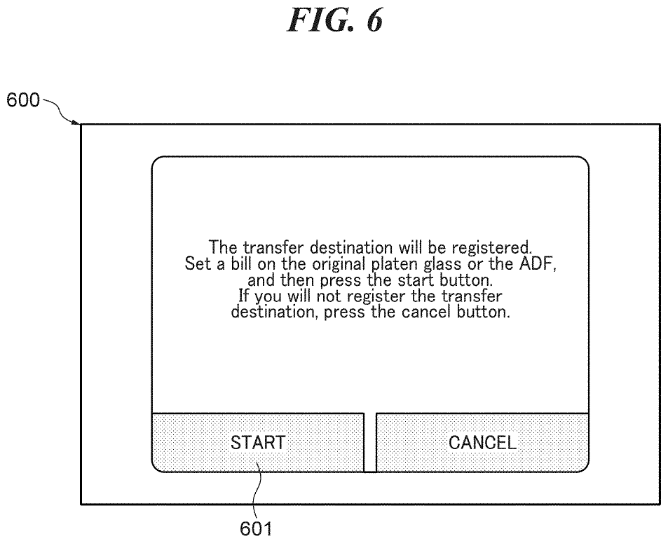

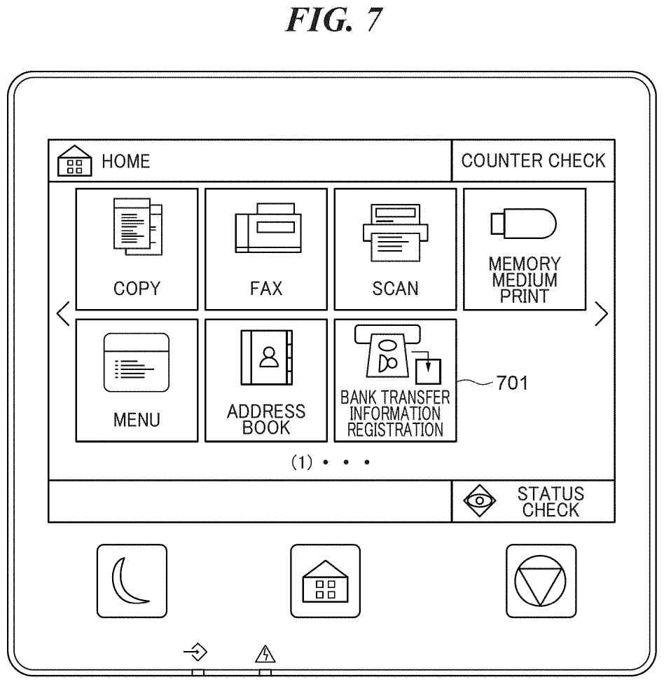

For example, in a case where the received token request response indicates a success of the authentication, in the step S406, the image forming apparatus 101 displays a setting screen 600 shown in FIG. 6 on the console section 116. When the user selects a start button 601 on the setting screen 600, the image forming apparatus 101 stores an access token included in the token request response in the storage 114 in association with the user information of the transfer source. When the access token is stored in the storage 114, the image forming apparatus 101 displays the registration screen 500 shown in FIG. 5B on the console section 116. On the registration screen 500 shown in FIG. 5B, the user ID and the password, input by the user, are displayed as turned characters (asterisks in the illustrated example), and the registered name input by the user is displayed as it is. After that, when the user selects a logout button 502, the screen is changed to the home screen. On this home screen, a bank transfer information registration button 701, appearing in FIG. 7, for registering a transfer destination is displayed in place of the banking service initial setting button 303. After that, the present process is terminated.

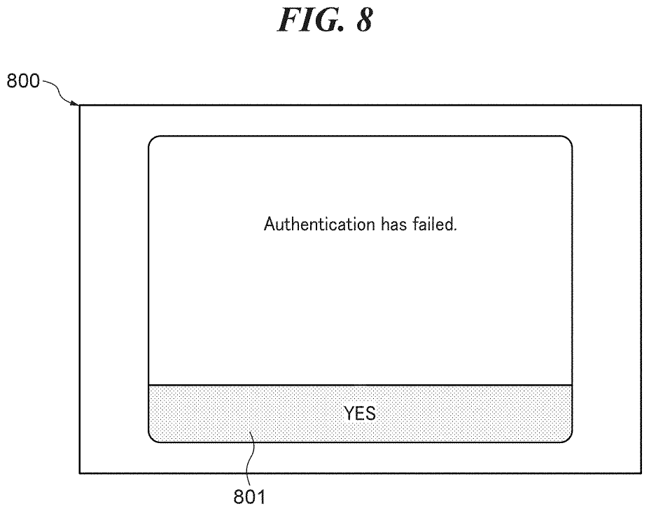

On the other hand, in a case where the received token request response indicates a failure of the authentication, in the step S406, the image forming apparatus 101 displays an authentication failure screen 800 shown in FIG. 8 on the console section 116. When the user presses a “YES” button 801 on the authentication failure screen 800, the registration screen 500 shown in FIG. 5A is displayed on the console section 116. After that, the present process is terminated.

Thus, in the present embodiment, the user information of the transfer source is registered. Note that when a registration changing button (not shown) which is displayed when the user selects the menu button 301, a screen for changing the registered user information of the transfer source is displayed on the console section 116.

Note that although in the present embodiment, the description is given of the configuration in which the user inputs the user information of the transfer source to the console section 116, this is not limitative. For example, the user may input the user information of the transfer source using the PC 102 connected to the image forming apparatus 101 via the network 100.

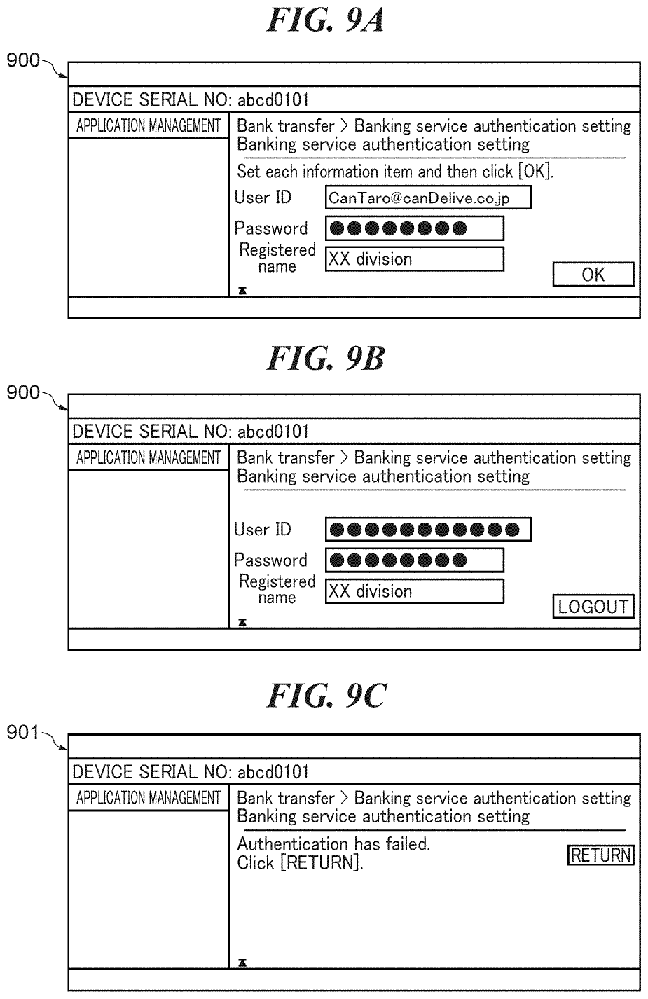

FIGS. 9A to 9C are diagrams each showing an example of a registration screen 900 displayed on a display section of the PC 102 appearing in FIG. 1. Similar to the above-described registration screen 500, the registration screen 900 is for registering user information of a transfer source, which is used when money is transferred by the banking service of the banking service resource server 105, and has a form similar to that of the registration screen 500.

When the user inputs a user ID, a password, and a registered name on the registration screen 900 as shown in FIG. 9A and selects a login button indicated by “OK”, the input user ID, password, and registered name are transmitted from the PC 102 to the image forming apparatus 101 via the network 100. The image forming apparatus 101 stores these information items in the storage 114, and the above-described steps S404 and S405 are executed.

In a case where the token request response indicates a success of the authentication, the registration screen 900 shown in FIG. 9B, on which the user ID and password input by the user are displayed as turned characters, and the registered name input by the user is displayed as it is, is displayed on the display section of the PC 102. On the other hand, in a case where the token request response indicates a failure of the authentication, an authentication failure screen 901 shown in FIG. 9C is displayed on the display section of the PC 102.

Incidentally, in recent years, although a service for transferring money using the Internet is provided, it is possible to perform bank transfer by using the Web API, without using a Web browser. In the Web API, differently from bank transfer via an ATM network or a Web browser, an account holder name of a transfer destination cannot be acquired even when a financial institution name, a branch office name, and an account number are notified. Further, an account holder name of a transfer destination associated with a financial institution name, an account number, and so forth stored in a host computer of the financial institution, cannot be acquired. For this reason, if a user makes a mistake in entering a financial institution name, a branch office name, an account type, or an account number, money is transferred to a wrong transfer destination. Further, positions of the financial institution name, the branch office name, the account type, and the account number, written e.g. in a general bill, are different depending on the format of a bill of an issuing source, and hence the positions are not uniform, differently from an account transfer request document. Therefore, whenever a bill is received, the user is required to confirm the financial institution name, the branch office name, the account type, the account number, and the charged amount, and then transfer money.

On the other hand, in the present embodiment, a number having the same number of digits as the account number, such as a 7-digit number, is extracted from image data of a bill. Transfer destination information included in the image data of the bill is acquired based on this number and position information of this number, and a transfer instruction notification including the acquired transfer destination information is transmitted to the banking service resource server 105.

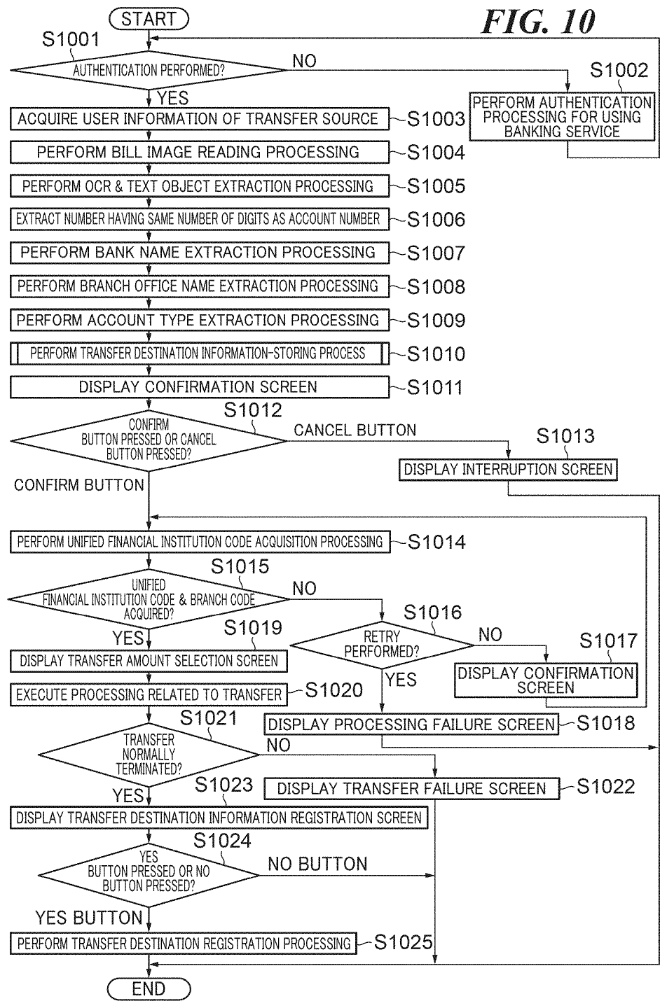

FIG. 10 is a flowchart of a transfer destination registration process performed by the image forming apparatus 101 appearing in FIG. 1. The transfer destination registration process is realized by the CPU 111 that loads a program stored in the ROM 112 into the RAM 113 and executes the loaded program. Note that in FIG. 10, it is assumed that the above-described transfer source user information registration process has already been executed. The transfer destination registration process is executed when a user sets a bill on which information on a transfer destination is written, on the reading section 118, and selects the bank transfer information registration button 701 on the home screen.

Referring to FIG. 10, first, the CPU 111 determines whether or not the authentication has already been performed by the banking service API authorization server 104 (step S1001).

If it is determined in the step S1001 that the authentication has not been performed by the banking service API authorization server 104 yet, the process proceeds to a step S1002. If it is determined in the step S1001 that the authentication has already been performed by the banking service API authorization server 104, the process proceeds to a step S1003.

In the step S1002, the CPU 111 performs authentication processing for using the banking service. In the authentication processing for using the banking service, the CPU 111 displays the registration screen 500 shown in FIG. 5A on the console section 116. Further, the CPU 111 transmits a token request including the user ID and the password, input by the user on the registration screen 500, to the banking service API authorization server 104, and receives a token request response indicating an authentication result from the banking service API authorization server 104. Then, the process returns to the step S1001.

In the step S1003, the CPU 111 acquires the registered user information of the transfer source. Then, the CPU 111 performs bill image reading processing (step S1004). More specifically, the CPU 111 causes the reading section 118 to read an image of the set bill and stores image data generated by reading the image in the RAM 113.

Then, the CPU 111 performs optical character recognition (OCR) and text object extraction on the image data stored in the RAM 113 (step S1005). More specifically, the CPU 111 performs OCR on the image data of the bill, which is stored in the RAM 113, searches the vicinity of each extracted character in right-left directions, and stores characters positioned within a range of a predetermined distance, in the RAM 113, as one character information item (one text object). This character information item includes numbers and marks. Then, the CPU 111 extracts a number having the same number of digits as the account number, e.g. a 7-digit number, from the character information item stored in the RAM 113 (step S1006). The CPU 111 stores the extracted 7-digit number in the RAM 113 together with the position information of this number in the image data of the bill.

Then, the CPU 111 executes bank name extraction processing (step S1007). More specifically, the CPU 111 extracts a character string having “bank” at its end from the character information item stored in the RAM 113. Further, the CPU 111 stores the extracted character string in the RAM 113 together with the position information of this character string in the image data of the bill. Then, the CPU 111 executes branch office name extraction processing (step S1008). More specifically, the CPU 111 extracts a character string having “branch office” or “head office” at its end from the character information stored in the RAM 113. Further, the CPU 111 stores the extracted character string in the RAM 113 together with the position information of this character string in the image data of the bill. Then, the CPU 111 executes account type extraction processing (step S1009). More specifically, the CPU 111 extracts a character string indicating an account type, such as “ordinary deposit”, “current deposit”, “ordinary”, or “current” from the character information item stored in the RAM 113. Further, the CPU 111 stores the extracted character string in the RAM 113 together with the position information of this character string in the image data of the bill.

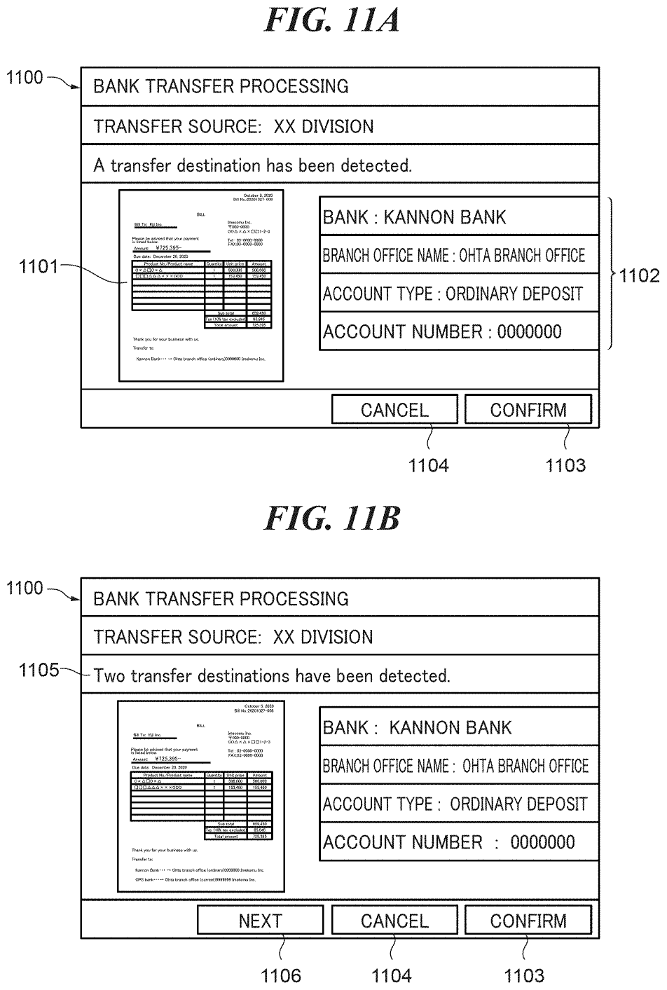

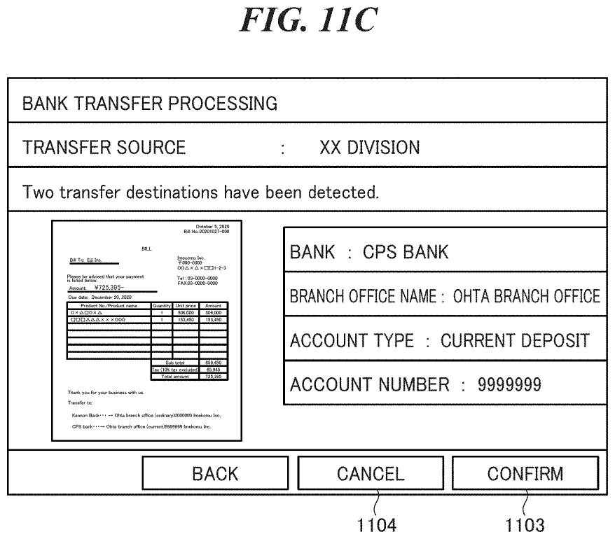

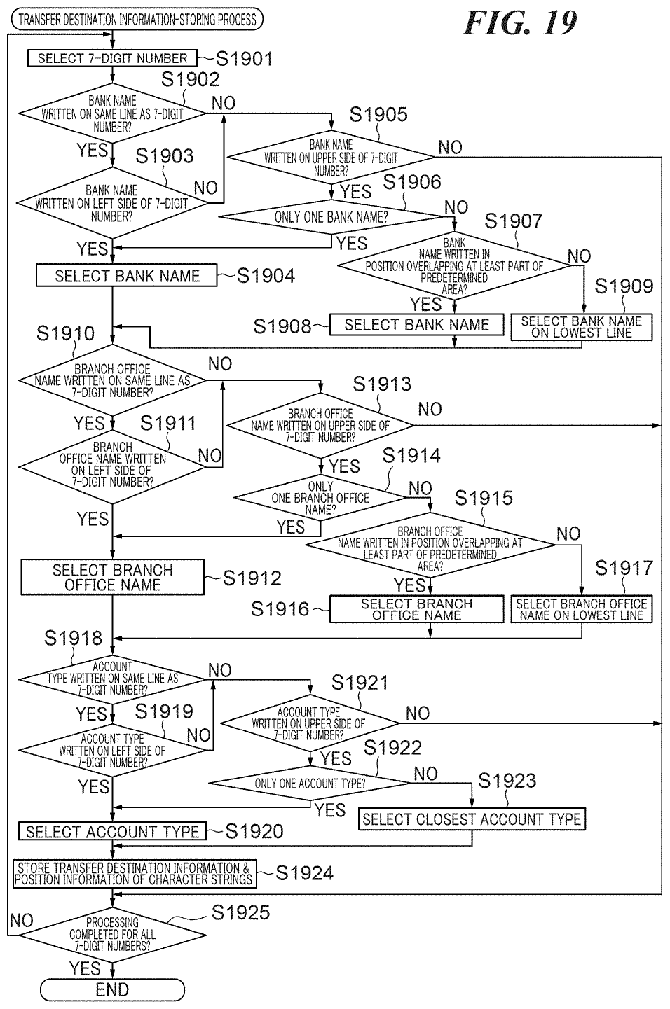

Then, the CPU 111 performs a transfer destination information-storing process, described hereinafter with reference to FIG. 19 (step S1010) to store the bank name, the branch office name, the account type, and the account number of the transfer destination, which are acquired from the character information item, as the transfer destination information, in the RAM 113. Then, the CPU 111 displays a confirmation screen 1100 shown in FIG. 11A on the console section 116 based on the stored transfer destination information (step S1011). On the confirmation screen 1100, there are displayed image data 1101 of the bill, transfer destination information 1102, a confirm button 1103, and a cancel button 1104. Note that in the present embodiment, for example, in a case where a plurality of different account numbers and the like are written on one bill read in the step S1004, a plurality of transfer destination information items associated with the respective account numbers are stored in the RAM 113. In a case where a plurality of transfer destination information items are stored in the RAM 113, the confirmation screen 1100 including a message 1105 indicating the number of stored transfer destination information items and a “next” button 1106, as shown in FIG. 11B, is displayed on the console section 116. When the user selects the “next” button 1106, another transfer destination information item stored in the RAM 113 is displayed, as shown in FIG. 11C, on the console section 116. Thus, in the present embodiment, it is possible to perform registration processing associated with a plurality of different account numbers written on one bill at one time (by selecting one of them). When one of the confirm button 1103 and the cancel button 1104 on the confirmation screen 1100 is selected by the user, the process proceeds to a step S1012. In the step S1012, the CPU 111 determines which of the confirm button 1103 and the cancel button 1104 has been pressed.

If it is determined in the step S1012 that the cancel button 1104 has been pressed, the process proceeds to a step S1013. If it is determined in the step S1012 that the confirm button 1103 has been pressed, the process proceeds to a step S1014.

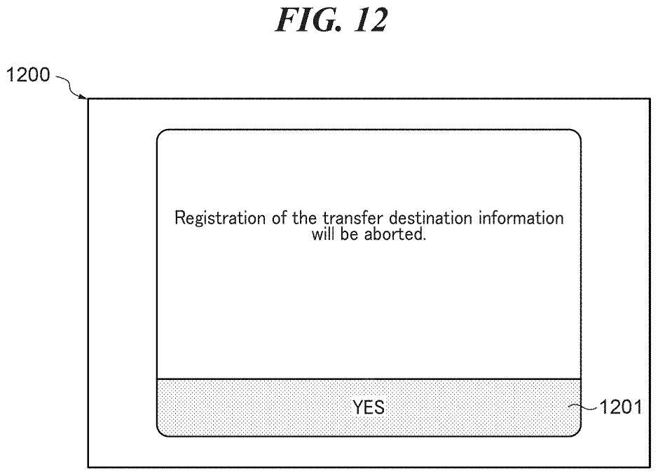

In the step S1013, the CPU 111 displays, on the console section 116, an abortion screen 1200 shown in FIG. 12 including a message that registration of the transfer destination information will be aborted. Then, when a “YES” button 1201 is pressed or a predetermined time period elapses, the present process is terminated.

In the step S1014, the CPU 111 executes unified financial institution code acquisition processing. More specifically, the CPU 111 transmits the transfer destination information stored in the RAM 113 to the unified financial institution code conversion server 108. The unified financial institution code conversion server 108 converts the bank name and the branch office name included in the received transfer destination information to a unified financial institution code and a branch code, respectively corresponding thereto, and transmits the unified financial institution code and the branch code to the image forming apparatus 101. Thus, in the present embodiment, the bank name and the branch office name included in the transfer destination information are converted to the unified financial institution code and the branch code. Note that although in the present embodiment, the description is given of the configuration in which the unified financial institution code conversion server 108 converts the bank name and the branch office name included in the transfer destination information to the unified financial institution code and the branch code, this is not limitative. For example, the CPU 111 may convert the bank name and the branch office name included in the transfer destination information to the unified financial institution code and the branch code based on a conversion table stored in the ROM 112.

Then, the CPU 111 determines whether or not the unified financial institution code and the branch code have been acquired (step S1015). If it is determined in the step S1015 that the unified financial institution code and the branch code have not been acquired, the CPU 111 determines whether or not retry of acquisition of the unified financial institution code has been performed (step S1016).

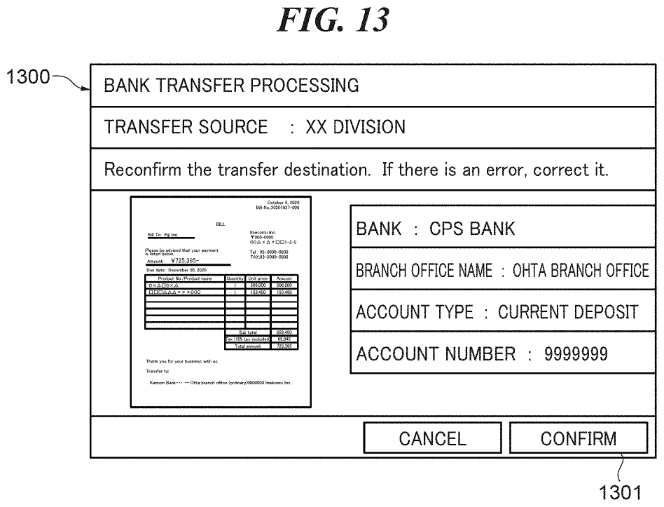

If it is determined in the step S1016 that retry of acquisition of the unified financial institution code has not been performed, the CPU 111 displays a transfer destination confirmation screen 1300 shown in FIG. 13 for prompting the user to confirm the transfer destination information, on the console section 116 (step S1017). In a case where the transfer destination information has an error, the user can input correct information on the transfer destination confirmation screen 1300. The CPU 111 changes the transfer destination information to the information input on the transfer destination confirmation screen 1300. With this, in a case where the transfer destination information set by the image forming apparatus 101 has an error, it is possible to correct the erroneous transfer destination information to the correct transfer destination information, and as a result, it is possible to transfer money to the desired transfer destination. When the user confirms the transfer destination confirmation screen 1300 and selects a confirm button 1301 on the transfer destination confirmation screen 1300, the process returns to the step S1014.

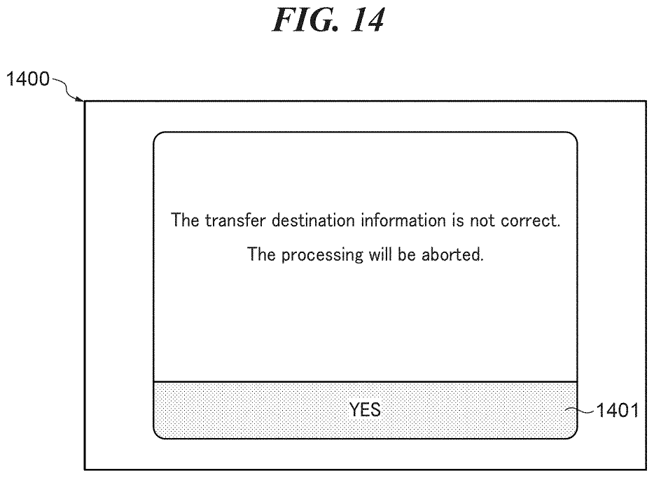

If it is determined in the step S1016 that retry of acquisition of the unified financial institution code has been performed, the CPU 111 displays a processing failure screen 1400 shown in FIG. 14 indicating a failure of processing, on the console section 116 (step S1018). Then, when a “YES” button 1401 is pressed or a predetermined time period elapses, the present process is terminated.

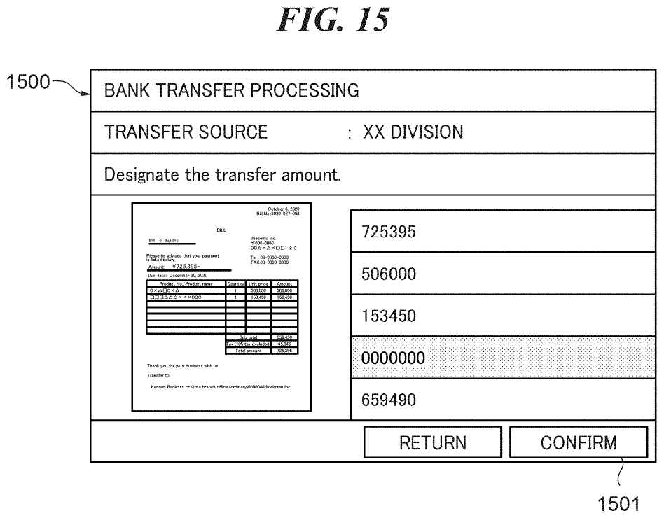

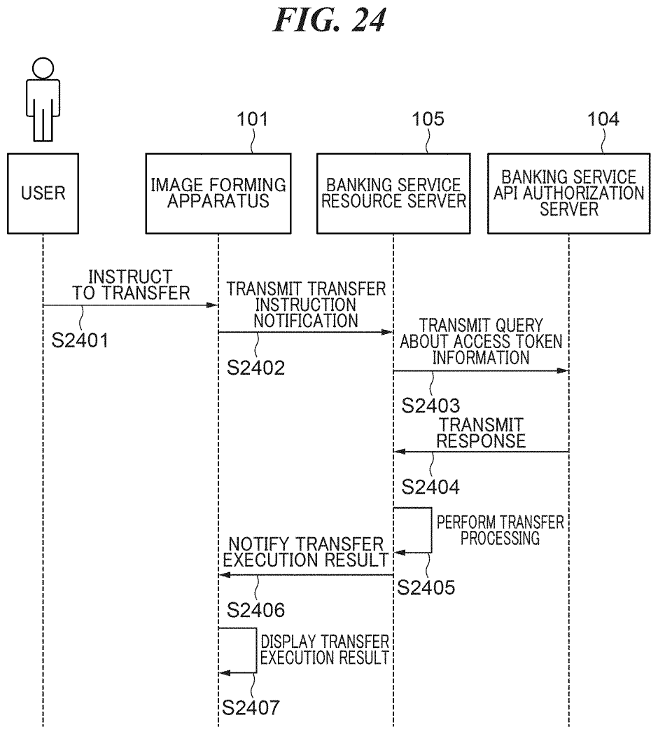

If it is determined in the step S1015 that the unified financial institution code and the branch code have been acquired, the CPU 111 displays a transfer amount selection screen 1500 shown in FIG. 15 for prompting the user to select a transfer amount on the console section 116 (step S1019). On the transfer amount selection screen 1500, a plurality of numbers extracted from the image data of the bill are displayed as options for selection. When the user selects one of the plurality of options as the transfer amount and presses a confirm button 1501 to give a transfer instruction, the CPU 111 executes bank transfer-related processing (step S1020). Specifically, in the step S1020, the CPU 111 performs processing in a step S2402 in a transfer process as a banking service, described hereinafter with reference to FIG. 24 (operation of a transmission control unit). Then, the CPU 111 determines whether or not the bank transfer has been normally terminated based on a result of execution of the bank transfer, which is notified from the banking service resource server 105, in a step S2406 in the transfer process as the banking service (step S1021).

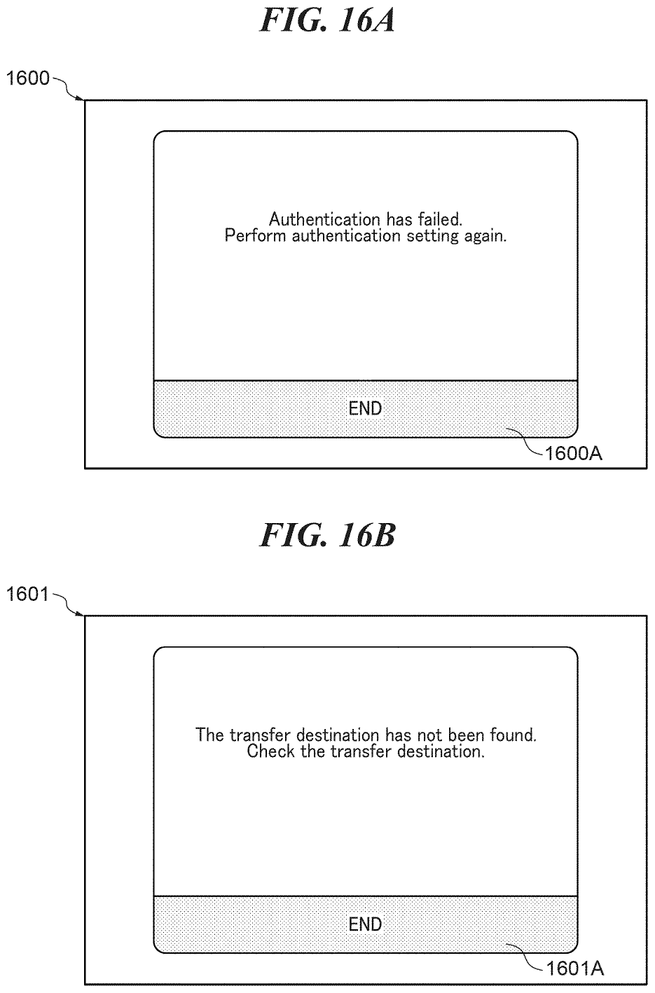

If it is determined in the step S1021 that the bank transfer has not been normally terminated, the CPU 111 displays an error screen on the console section 116 (step S1022). For example, in a case where authentication processing fails, an error screen 1600, shown in FIG. 16A, indicating this fact is displayed on the console section 116. Further, in a case where the corresponding transfer destination has not been found, an error screen 1601 shown in FIG. 16B is displayed on the console section 116. Then, when an “END” button 1600A or 1601A on an associated one of the error screens is pressed or a predetermined time period elapses, the present process is terminated.

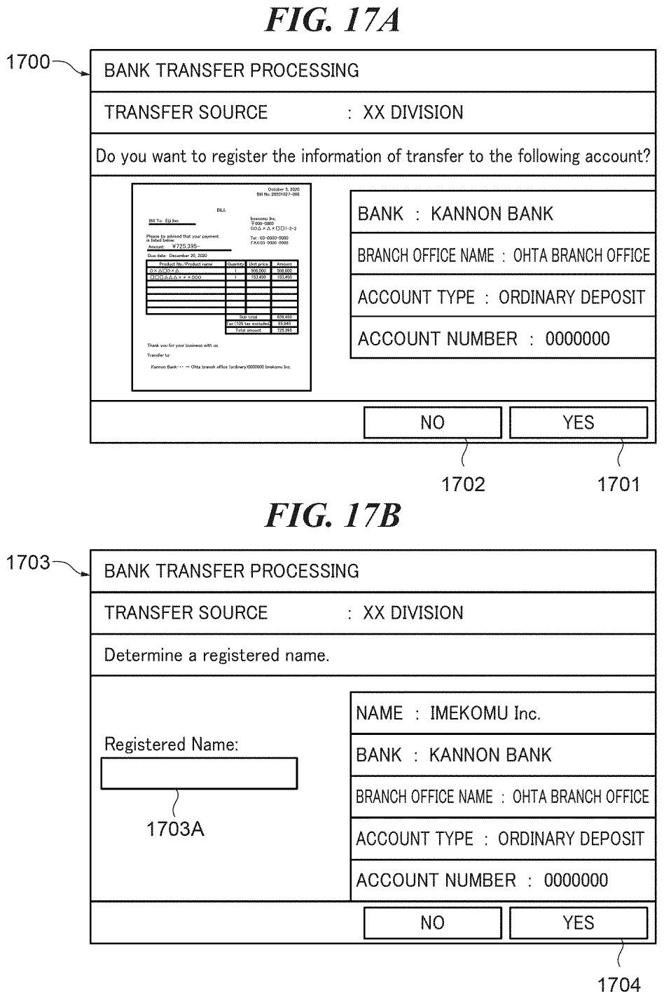

If it is determined in the step S1021 that the bank transfer has been normally terminated, the CPU 111 displays a transfer destination information registration screen 1700 shown in FIG. 17A on the console section 116 (step S1023). On the transfer destination information registration screen 1700, the transfer destination information used for the bank transfer, more specifically, the bank name, the branch office name, the account type, and the account number of the transfer destination are displayed. The user can instruct the image forming apparatus 101 to register these information items by selecting an “YES” button 1701 on the transfer destination information registration screen 1700. Further, the user can instruct the image forming apparatus 101 not to register these information items by selecting a “NO” button 1702 on the transfer destination information registration screen 1700. When the user selects one of the “YES” button 1701 and the “NO” button 1702, the process proceeds to a step S1024. In the step S1024, the CPU 111 determines which of the “YES” button 1701 and the “NO” button 1702 has been pressed.

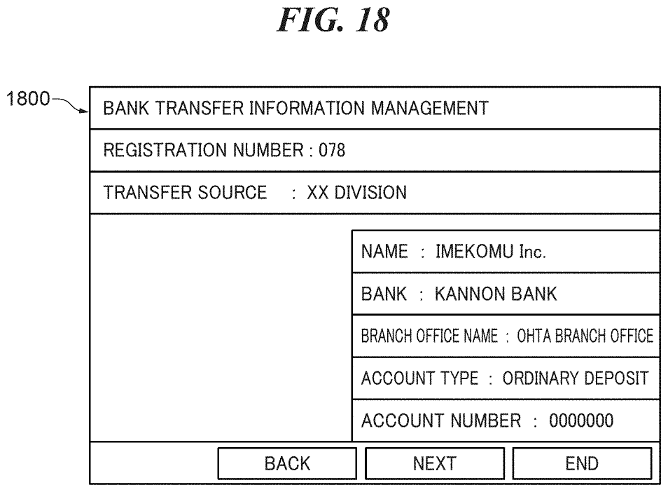

If it is determined in the step S1024 that the “NO” button 1702 has been pressed, the present process is terminated. If it is determined in the step S1024 that the “YES” button 1701 has been pressed, the CPU 111 performs transfer destination registration processing (step S1025). More specifically, the CPU 111 displays a registered name-setting screen 1703 shown in FIG. 17B for setting a registered name of the transfer destination information on the console section 116. When the user inputs a registered name of the transfer destination information to an entry box 1703 of the registered name on the registered name-setting screen 1703 and selects, i.e. presses a “YES” button 1704, the CPU 111 registers the transfer information in a bank transfer information management table stored in the storage 114. The transfer information includes the transfer destination information, such as the bank name, the branch office name, the account type, and the account number of the transfer destination, included in a transfer instruction notification, described hereinafter, which has been transmitted to the banking service resource server 105 in the step S1020, and position information of these character strings in the image data. Further, the transfer information includes the registered name input on the registered name-setting screen 1703. Furthermore, the transfer information includes position information of a transfer amount in the image data. In the present embodiment, the user can confirm the registered transfer information on the console section 116. For example, a transfer information management screen 1800 shown in FIG. 18 is displayed on the console section 116 according to an instruction received from the user. On the transfer information management screen 1800, for example, the bank name, the branch office name, the account type, and the account number in the registered transfer information are displayed. When the step S1025 is terminated, the present process is terminated.

FIG. 19 is a flowchart of the transfer destination information-storing process in the step S1010 in FIG. 10.

Referring to FIG. 19, the CPU 111 selects one of the plurality of 7-digit numbers extracted in the step S1006 (step S1901). Further, the CPU 111 acquires the position information of the selected 7-digit number. Then, the CPU 111 determines whether or not a bank name is written on the same line as the selected 7-digit number in the image data of the bill (step S1902). This bank name is the character string extracted in the step S1007, i.e. the character string having “bank” at its end.

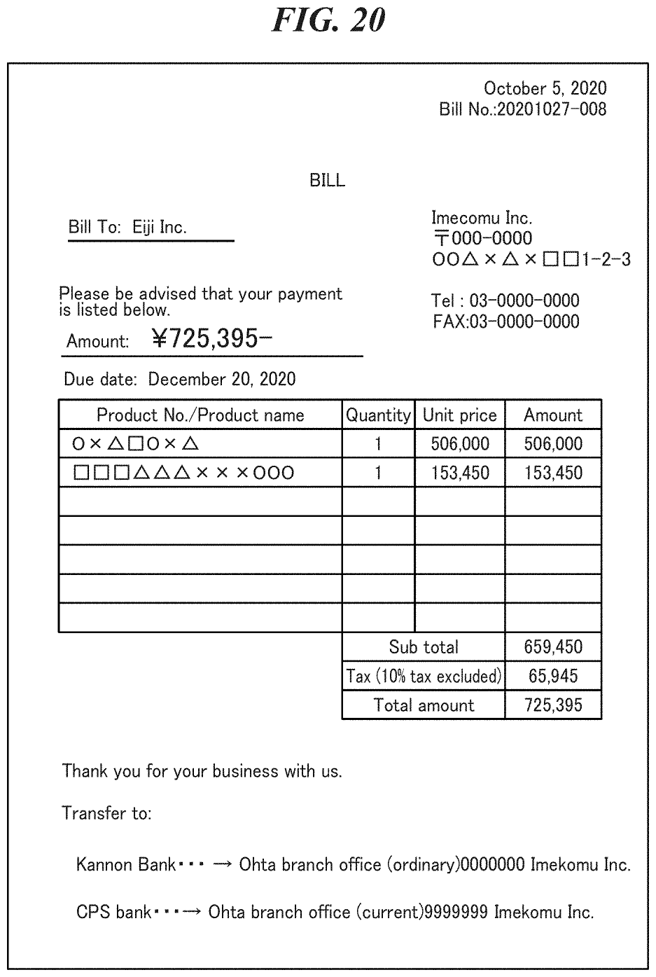

If it is determined in the step S1902 that a bank name is written on the same line as the selected 7-digit number, the CPU 111 determines whether or not the bank name is written on the left side of the selected 7-digit number in the image data of the bill (step S1903). If it is determined in the step S1903 that the bank name is written on the left side of the selected 7-digit number, the CPU 111 selects this bank name (step S1904). For example, in a case where the selected 7-digit number is “0000000” in the image data of the bill shown in FIG. 20, in the step S1904, “Kannon Bank” written on the left side of this 7-digit number is selected. Then, the process proceeds to a step S1910, described hereinafter. Note that although the relative position of the bank name to the 7-digit number is defined as the left side based on the writing form of the bill in Japan, this relative position may be changed according to a writing form of the bill, used in each country. The same applies to respective relative positions of the branch office name and the account type to the 7-digit number, described hereinafter.

If it is determined in the step S1902 that no bank name is written on the same line as the selected 7-digit number, or if it is determined in the step S1903 that the bank name is not written on the left side of the selected 7-digit number, the process proceeds to a step S1905. In the step S1905, the CPU 111 determines whether or not a bank name is written on the upper side of the selected 7-digit number in the image data of the bill. More specifically, the CPU 111 determines whether or not a bank name is written on a line within a range of a predetermined number of lines, e.g. within a range of one to three lines, on the upper side of the selected 7-digit number in the image data of the bill. If it is determined in the step S1905 that no bank name is written on the upper side of the selected 7-digit number, the process proceeds to a step S1925, described hereinafter. If it is determined in the step S1905 that a bank name is written on the upper side of the selected 7-digit number, the CPU 111 determines whether or not only one bank name is written on the upper side of the selected 7-digit number in the image data of the bill (step S1906).

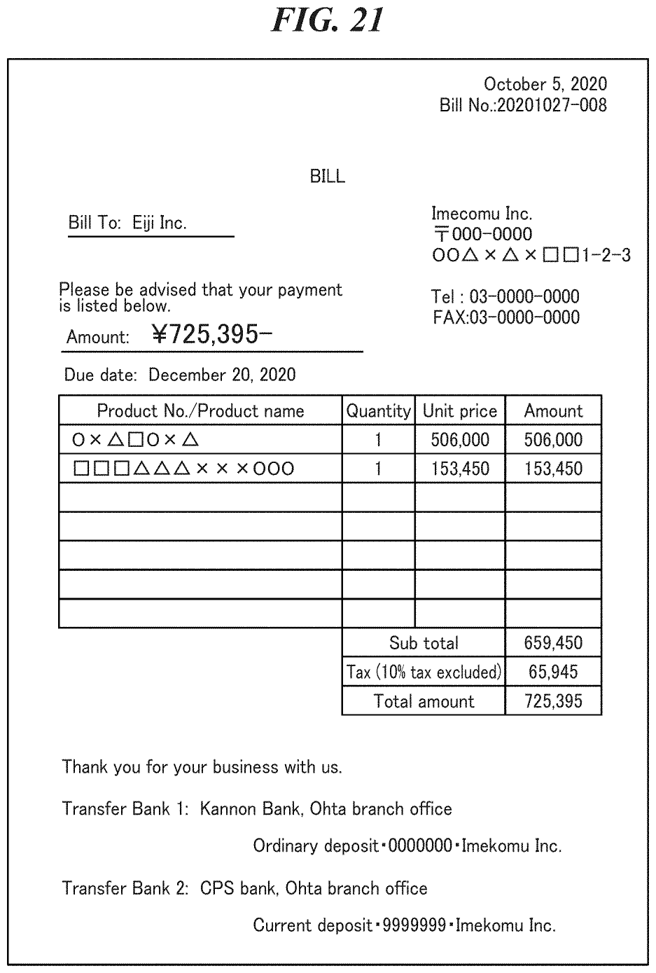

If it is determined in the step S1906 that only one bank name is written on the upper side of the selected 7-digit number, the process proceeds to the step S1904. For example, in a case where the selected 7-digit number is “0000000” in the image data of the bill shown in FIG. 21, in the step S1904, “Kannon Bank” written on the upper side of this 7-digit number is selected. Then, the process proceeds to the step S1910, described hereinafter.

If it is determined in the step S1906 that more than one bank names are written on the upper side of the selected 7-digit number, the process proceeds to a step S1907. In the step S1907, the CPU 111 determines whether or not a bank name is written in a position overlapping at least part of a predetermined area which has a width approximately similar to the width of the selected 7-digit number and is displaced upward from the 7-digit number.

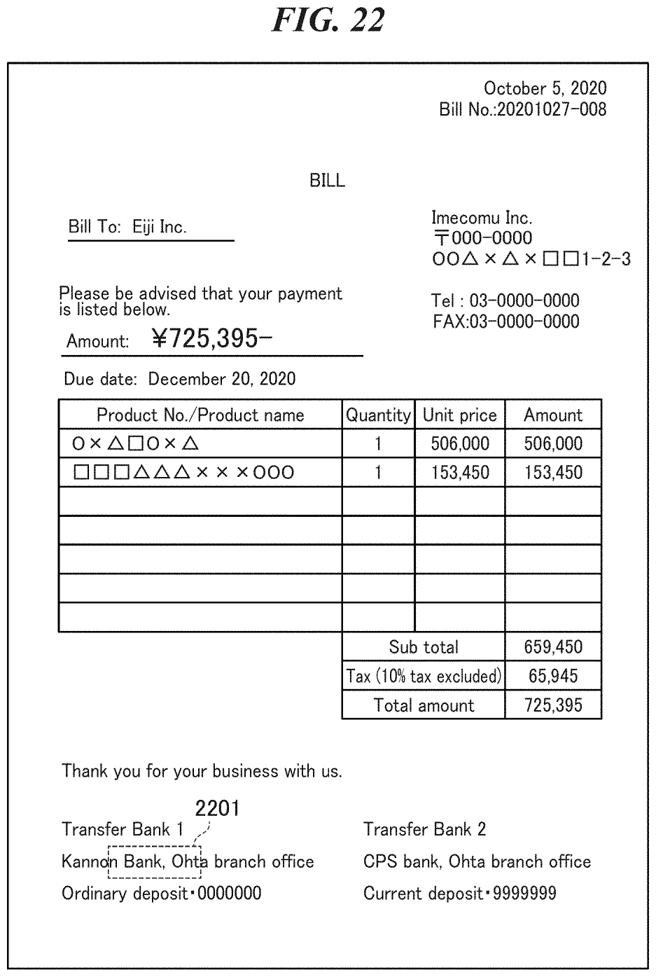

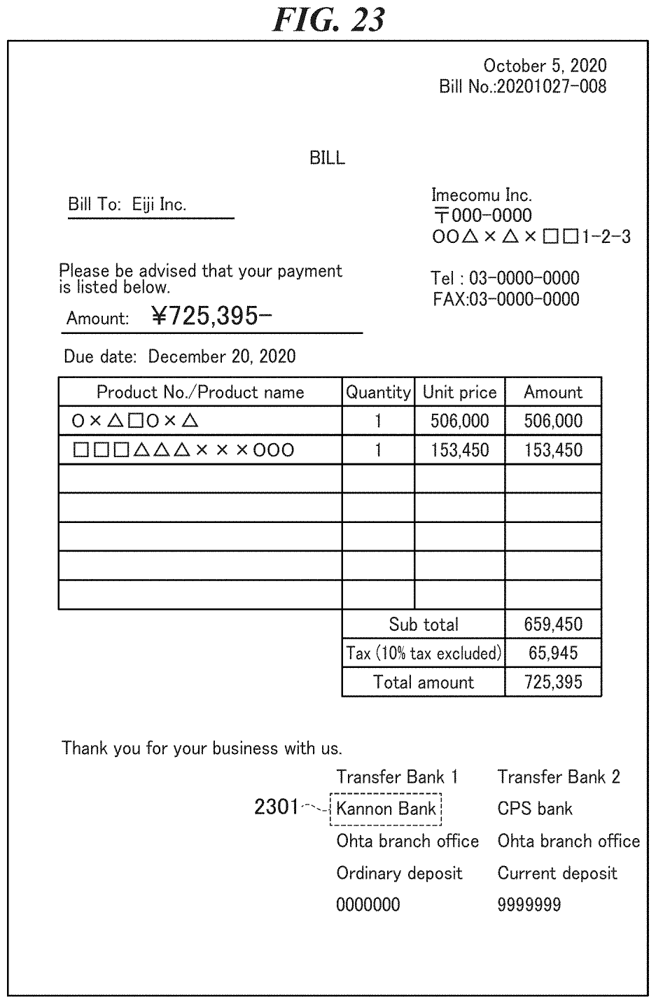

If it is determined in the step S1907 that a bank name is written in a position overlapping at least part of the predetermined area displaced upward from the 7-digit number, the CPU 111 selects this bank name (step S1908). For example, in a case where the selected 7-digit number is “0000000” in a bill shown in FIG. 22 or 23, “Kannon Bank” and “CPS bank” are written on the upper side of this 7-digit number. In the step S1904, out of “Kannon Bank” and “CPS bank”, “Kannon Bank” is selected which is in the position overlapping at least part of a predetermined area (such as an area 2201 or 2301) which has a width approximately similar to the width of “0000000” and is displaced upward from “0000000” in the image data. Then, the process proceeds to the step S1910, described hereinafter.

If it is determined in the step S1907 that no bank name is written in a position overlapping at least part of the predetermined area displaced upward from the 7-digit number of the image data, the process proceeds to a step S1909. In the step S1909, the CPU 111 selects a bank name written on the lowest line out of the bank names written on the upper side of the selected 7-digit number. Thus, in the present embodiment, the bank name of the transfer destination included in the image data of the bill is identified based on a positional relationship between the selected 7-digit number and a character string having “bank” at its end. This makes it possible to set the bank name of the transfer destination without forcing a user to input data.

Then, the CPU 111 determines whether or not a branch office name is written on the same line as the selected 7-digit number in the image data of the bill (step S1910). This branch office name is the character string extracted in the step S1008, i.e. the character string having “branch office” or “head office” at its end.

If it is determined in the step S1910 that a branch office name is written on the same line as the selected 7-digit number, the CPU 111 determines whether or not the branch office name is written on the left side of the selected 7-digit number in the image data of the bill (step S1911). If it is determined in the step S1911 that the branch office name is written on the left side of the selected 7-digit number, the CPU 111 selects this branch office name (step S1912). For example, in a case where the selected 7-digit number is “0000000” in the image data of the bill shown in FIG. 20, in the step S1912, “Ohta branch office” written on the left side of this 7-digit number is selected. Then, the process proceeds to a step S1918, described hereinafter.

If it is determined in the step S1910 that no branch office name is written on the same line as the selected 7-digit number, or if it is determined in the step S1911 that the branch office name is not written on the left side of the selected 7-digit number, the process proceeds to a step S1913. In the step S1913, the CPU 111 determines whether or not a branch office name is written on the upper side of the selected 7-digit number in the image data of the bill. More specifically, the CPU 111 determines whether or not a branch office name is written on a line within a range of a predetermined number of lines, e.g. within a range of one or two lines, on the upper side of the selected 7-digit number in the image data of the bill. If it is determined in the step S1913 that no branch office name is written on the upper side of the selected 7-digit number, the process proceeds to the step S1925, described hereinafter. If it is determined in the step S1913 that a branch office name is written on the upper side of the selected 7-digit number, the CPU 111 determines whether or not only one branch office name is written on the upper side of the selected 7-digit number in the image data of the bill (step S1914).

If it is determined in the step S1914 that only one branch office name is written on the upper side of the selected 7-digit number, the process proceeds to the step S1912. If it is determined in the step S1914 that more than one branch office names are written on the upper side of the selected 7-digit number, the process proceeds to a step S1915. In the step S1915, the CPU 111 determines whether or not a branch office name is written in a position overlapping at least part of a predetermined area which has a width approximately similar to the width of the selected 7-digit number and is displaced upward from the 7-digit number of the image data.

If it is determined in the step S1915 that a branch office name is written in a position overlapping at least part of the predetermined area displaced upward from the 7-digit number of the image data, the CPU 111 selects this branch office name (step S1916). Then, the process proceeds to the step S1918, described hereinafter.

If it is determined in the step S1915 that no branch office name is written in a position overlapping at least part of the predetermined area displaced upward from the 7-digit number of the image data, the process proceeds to a step S1917. In the step S1917, the CPU 111 selects a branch office name written on the lowest line out of the branch office names written on the upper side of the selected 7-digit number. Thus, in the present embodiment, the branch office name of the transfer destination included in the image data is identified based on a positional relationship between the selected 7-digit number and a character string having “branch office” or “head office” at its end in the image data of the bill. This makes it possible to set the branch office name of the transfer destination without forcing a user to input data.

Then, the CPU 111 determines whether or not an account type is written on the same line as the selected 7-digit number in the image data of the bill (step S1918). This account type is the character string extracted in the step S1009, i.e. the character string, such as “ordinary deposit”, “current deposit”, “ordinary”, and “current”.

If it is determined in the step S1918 that an account type is written on the same line as the selected 7-digit number, the process proceeds to a step S1919. In the step S1919, the CPU 111 determines whether or not the account type is written on the left side of the selected 7-digit number in the image data of the bill. If it is determined in the step S1919 that the account type is written on the left side of the selected 7-digit number, the CPU 111 selects this account type (step S1920). For example, in a case where the selected 7-digit number is “0000000” in the image data of the bill shown in FIG. 20, in the step S1920, “ordinary” written on the left side of this 7-digit number is selected. Then, the process proceeds to a step S1924, described hereinafter.

If it is determined in the step S1918 that no account type is written on the same line as the selected 7-digit number, or if it is determined in the step S1919 that the account type is not written on the left side of the selected 7-digit number, the process proceeds to a step S1921. In the step S1921, the CPU 111 determines whether or not an account type is written on the upper side of the selected 7-digit number in the image data of the bill. More specifically, the CPU 111 determines whether or not an account type is written on a line within a range of a predetermined number of lines, e.g. within a range of one line, on the upper side of the selected 7-digit number in the image data of the bill. If it is determined in the step S1921 that no account type is written on the upper side of the selected 7-digit number, the process proceeds to the step S1925, described hereinafter. If it is determined in the step S1921 that an account type is written on the upper side of the selected 7-digit number, the CPU 111 determines whether or not only one account type is written on the upper side of the selected 7-digit number in the image data of the bill (step S1922).

If it is determined in the step S1922 that only one account type is written on the upper side of the selected 7-digit number, the process proceeds to the step S1920. If it is determined in the step S1922 that more than one account types are written on the upper side of the selected 7-digit number, the process proceeds to a step S1923. In the step S1923, the CPU 111 selects an account type closest to the selected 7-digit number out of the account types written on the upper side of the selected 7-digit number. Thus, in the present embodiment, the account type of the transfer destination included in the image data is identified based on a positional relationship between the selected 7-digit number and a character string whose end indicates an account type in the image data of the bill. This makes it possible to set the account type of the transfer destination without forcing a user to input data.

Then, the CPU 111 stores the transfer destination information including the selected 7-digit number, the bank name, the branch office name, and the account type, and the position information of these character strings, in the RAM 113 (step S1924). Then, the CPU 111 determines whether or not the process has been completed for all of the 7-digit numbers extracted in the step S1005 (step S1925).

If it is determined in the step S1925 that the process has not been completed for any of the 7-digit numbers extracted in the step S1005, the process returns to the step S1901, wherein the CPU 111 selects another 7-digit number. Thus, in the present embodiment, the above-described process is performed for all of the 7-digit numbers extracted from the image data of the bill. With this, in a case where a plurality of different account numbers and the like are written in one bill read in the step S1004 as shown in FIGS. 20 to 23, it is possible, by reading the bill only once, to store a plurality of transfer destination information items associated with the plurality of account numbers, respectively, in the RAM 113. If it is determined in the step S1925 that the process has been completed for all of the 7-digit numbers extracted in the step S1005, the present process is terminated.

FIG. 24 is a sequence diagram of the transfer process as the banking service in the present embodiment.

Referring to FIG. 24, the user gives a transfer instruction (step S2401). More specifically, as the transfer instruction, the user selects the transfer amount on the transfer amount selection screen 1500 shown in FIG. 15 and further presses the confirm button 1501. The image forming apparatus 101 having received the transfer instruction from the user transmits a transfer instruction notification to the banking service resource server 105 (step S2402). The transfer instruction notification includes the transfer amount selected by the user on the transfer amount selection screen 1500. Further, the transfer instruction notification includes the transfer destination information. This transfer destination information is the transfer destination information displayed on the confirmation screen 1100 when the user selects the confirm button 1103, more specifically, the bank name, the branch office name, the account type, and the account number of the transfer destination. Further, the transfer instruction notification includes the access token. This access token is the access token stored in the storage 114 in advance in the transfer source user information registration process in FIG. 4.

The banking service resource server 105 acquires the access token included in the received transfer instruction notification. The banking service resource server 105 transmits a query about the information of the acquired access token to the banking service API authorization server 104 (step S2403). The banking service API authorization server 104 transmits a response to the query to the banking service resource server 105 (step S2404). More specifically, the banking service API authorization server 104 transmits the corresponding information of the access token to the banking service resource server 105. The banking service resource server 105 determines validity based on the received information of the access token. For example, in a case where the information is valid, the banking service resource server 105 executes transfer processing for transferring money using the transfer destination information and the transfer amount, included in the transfer instruction notification received from the image forming apparatus 101 (step S2405). On the other hand, in a case where the information is invalid, the banking service resource server 105 does not execute the above-mentioned transfer processing.

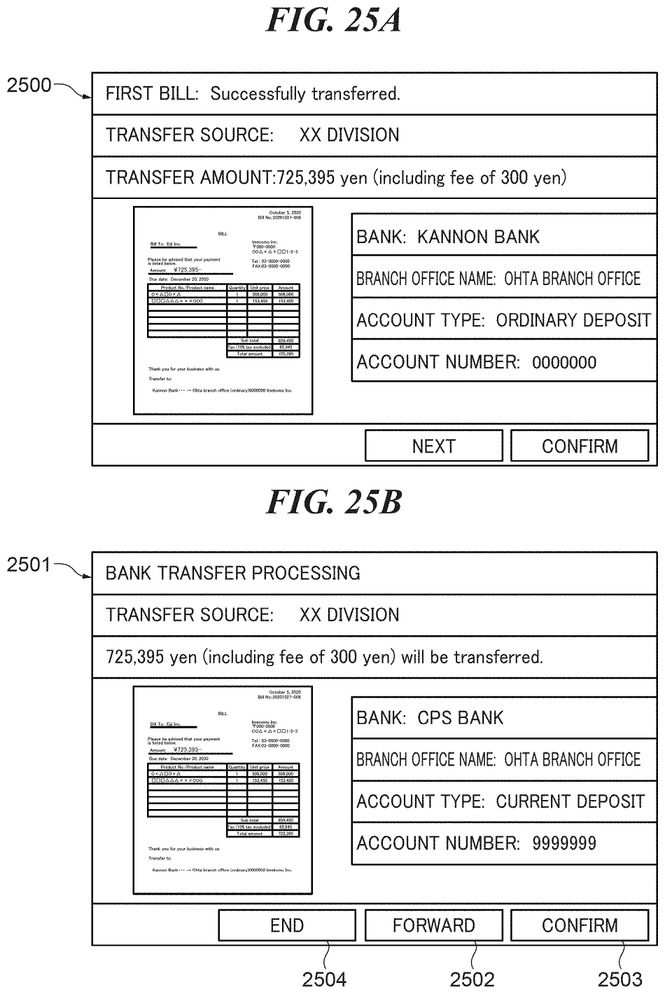

Then, the banking service resource server 105 notifies the image forming apparatus 101 of an execution result of the transfer processing (step S2406). The image forming apparatus 101 displays the execution result of the transfer processing on the console section 116 based on this notification (step S2407). For example, the image forming apparatus 101 displays a transfer confirmation screen 2500 shown in FIG. 25A on the console section 116 as the execution result of the transfer processing. The transfer confirmation screen 2500 includes a message indicating a success of the transfer processing and the transfer amount. After that, the present process is terminated.

According to the above-described embodiment, the transfer destination information included in the image data of the bill is acquired based on the selected 7-digit number and the position information of this number, and the transfer instruction notification including the acquired transfer destination information is transmitted to the banking service resource server 105. This makes it possible to reduce time and labor of a user required to set the transfer destination information.

Further, in the above-described embodiment, when the user presses the confirm button 1103 as the transmission instruction on the confirmation screen 1100 on which the transfer destination information is displayed, the transfer instruction notification is transmitted to the banking service resource server 105. This makes it possible to prevent execution of transfer processing using unintended transfer destination information.

In the above-described embodiment, the transfer destination information includes a bank name, a branch office name, an account type, and an account number of a transfer destination. This makes it possible to reduce time and labor of a user required to set the bank name, the branch office name, the account type, and the account number of the transfer destination.

Further, in the above-described embodiment, transfer destination information included in a transfer instruction notification transmitted to the banking service resource server 105, and the position information of the transfer destination information in image data are registered in the bank transfer information management table. This makes it possible to reuse the transfer destination information acquired once.

Next, transfer using the transfer destination information registered in the bank transfer information management table will be described.

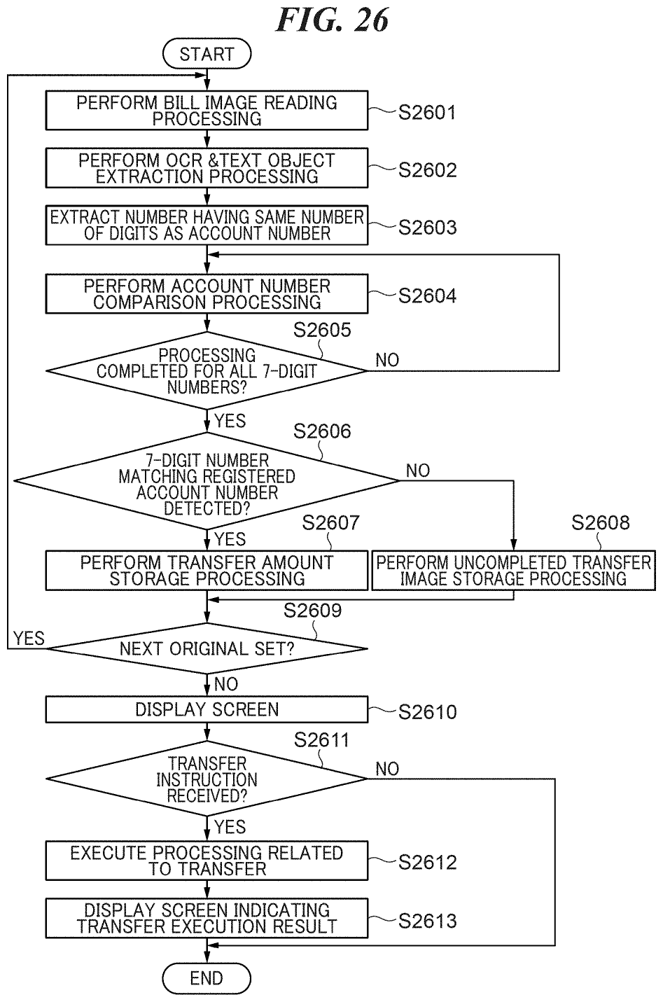

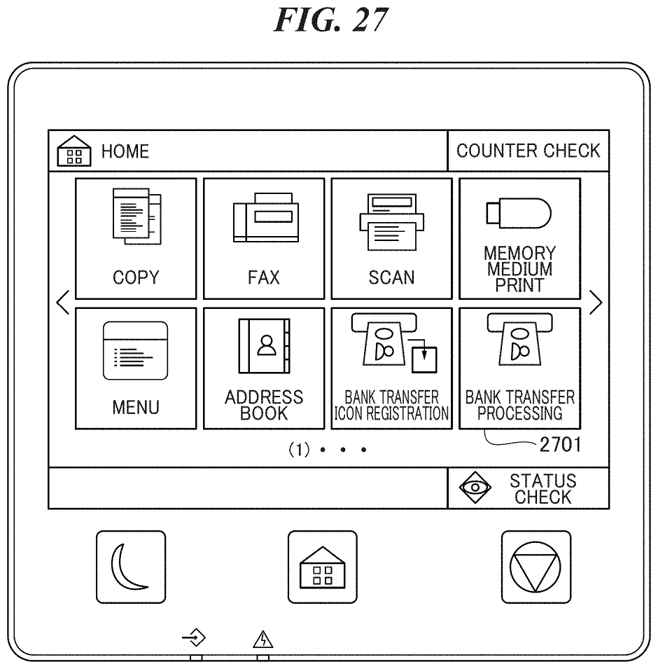

FIG. 26 is a flowchart of a transfer control process performed by the image forming apparatus 101 appearing in FIG. 1. The transfer control process is realized by the CPU 111 that loads a program stored in the ROM 112 into the RAM 113 and executes the loaded program. Note that the transfer control process is executed when a bill is set on the reading section 118, and a short-cut icon 2701 appearing in FIG. 27 on the home screen displayed on the console section 116 is selected by the user.

Referring to FIG. 26, first, the CPU 111 performs bill image reading processing (step S2601). More specifically, the CPU 111 causes the reading section 118 to read an image of the set bill and stores generated image data in the RAM 113. Note that in a case where a plurality of bills are set, in the step S2601, the CPU 111 causes the reading section 118 to read an image of one of the plurality of set bills and stores generated image data in the RAM 113.

Then, similar to the above-described step S1005, the CPU 111 performs OCR and text object extraction on the image data stored in the RAM 113 (step S2602). Then, the CPU 111 extracts a number having the same number of digits as the account number, e.g. a 7-digit number, from character information stored in the RAM 113 (step S2603). The CPU 111 stores the extracted 7-digit number in the RAM 113 together with the position information of this number in the image data of the bill. Note that in a case where a plurality of 7-digit numbers are extracted from the image data of the bill, the plurality of extracted 7-digit numbers and the position information of each 7-digit number are stored in the RAM 113. Then, the CPU 111 selects one of the plurality of 7-digit numbers stored in the RAM 113. The CPU 111 performs account number comparison processing (step S2604). More specifically, the CPU 111 compares the selected 7-digit number with account numbers registered in the bank transfer information management table. In a case where the 7-digit number matches an account number registered in the bank transfer information management table, the CPU 111 compares the position information of this 7-digit number and the position information of the matching account number. In a case where these position information items match each other, the CPU 111 stores this 7-digit number and the position information of this 7-digit number in the RAM 113 in association with the transfer destination information including the matching account number.

Then, the CPU 111 determines whether or not the process has been completed for all of the 7-digit numbers stored in the RAM 113 (step S2605). If it is determined in the step S2605 that the process has not been completed for any of the 7-digit numbers stored in the RAM 113, the CPU 111 selects another one of the plurality of 7-digit numbers stored in the RAM 113. Then, the process returns to the step S2604.

If it is determined in the step S2605 that the process has been completed for all of the 7-digit numbers stored in the RAM 113, the process proceeds to a step S2606. In the step S2606, the CPU 111 determines whether or not a 7-digit number matching an account number registered in the bank transfer information management table has been detected.

If it is determined in the step S2606 that a 7-digit number matching an account number registered in the bank transfer information management table has been detected, the CPU 111 executes transfer amount storage processing (step S2607). More specifically, the CPU 111 extracts a number in a position indicated by the position information of the transfer amount registered in the bank transfer information management table, from the image data of the bill. Further, the CPU 111 stores the extracted number in the RAM 113 in association with the image data of the bill. Then, the process proceeds to a step S2609, described hereinafter.

If it is determined in the step S2606 that no 7-digit number matching any account number registered in the bank transfer information management table has been detected, the CPU 111 executes uncompleted transfer image storage processing (step S2608). More specifically, the CPU 111 holds the image data of the bill from which no 7-digit number matching any account number registered in the bank transfer information management table has been detected, in the RAM 113. Then, the CPU 111 determines whether or not there is a next original which is set (step S2609).

If it is determined in the step S2609 that there is a next original which is set, the process returns to the step S2601. If it is determined in the step S2609 that there is no next original, the CPU 111 displays a screen on the console section 116 (step S2610). For example, in the step S2610, in a case where no 7-digit number matching any account number registered in the bank transfer information management table has been detected from the image data items of all of the read bills, an error screen indicating that no account number has been detected is displayed on the console section 116. When the error screen is displayed, the present process is terminated. On the other hand, in a case where a 7-digit number matching an account number registered in the bank transfer information management table has been detected from any of the image data items of the read bills, a transfer confirmation screen 2501 shown in FIG. 25B is displayed on the console section 116, in the step S2610. On the transfer confirmation screen 2501, the image data of the bill, the transfer amount associated with this image data, and the transfer destination information associated with the 7-digit number by the account number comparison processing in the step S2604 are displayed. When a “forward” button 2502 is selected by the user on the transfer confirmation screen 2501, the transfer destination information associated with a 7-digit number extracted from image data of another bill is displayed.

Then, the CPU 111 determines whether or not a transfer instruction has been received from the user (step S2611). In the step S2611, for example, in a case where a user's operation of pressing a confirm button 2503 on the transfer confirmation screen 2501 has been detected, the CPU 111 determines that a transfer instruction has been received from the user. On the other hand, in a case where a user's operation of pressing an end button 2504 on the transfer confirmation screen 2501 has been detected, the CPU 111 determines that no transfer instruction has been received from the user.

If it is determined in the step S2611 that no transfer instruction has been received from the user, the present process is terminated without performing transfer processing. If it is determined in the step S2611 that the transfer instruction has been received from the user, the CPU 111 executes, similar to the above-described step S1020, the bank transfer-related processing (step S2612) and transmits a transfer instruction notification to the banking service resource server 105. This transfer instruction notification includes the above-mentioned access token. Further, this transfer instruction notification includes the transfer destination information and the transfer amount displayed on the transfer confirmation screen 2501 when the user has pressed the confirm button 2503 for the transfer instruction. In a case where a plurality of bills are read, the processing related to the transfer (step S2612) is executed for each bill, and when the processing is completed for all of the bills, the process proceeds to a step S2613. In the step S2613, the CPU 111 displays a screen indicating a result of execution of the transfer processing on the console section 116 (step S2613). For example, in a case where the transfer processing is successful, the transfer confirmation screen 2500 including a message indicating a success of the transfer processing is displayed on the console section 116. Further, in a case where the transfer processing fails, an error screen indicating details of the error, such as the error screen 1600 or the error screen 1601, is displayed. After that, the present process is terminated.

In the above-described embodiment, in a case where the transfer destination information including an account number matching a 7-digit number is registered, and the position information of this 7-digit number matches the position information of the matching account number, a transfer instruction notification including the transfer destination information is transmitted to the banking service resource server 105. This makes it possible to perform bank transfer using the registered transfer destination information without forcing a user to input the transfer destination information.

Further, in the above-described embodiment, in a case where the transfer destination information including an account number matching a 7-digit number has been registered, and the position information of this 7-digit number matches the position information of the matching account number, a transfer instruction notification including, as the transfer amount, a number written in a position in image data of a bill, which is indicated by the position information of a transfer amount registered in the bank transfer information management table, is transmitted to the banking service resource server 105. This makes it possible to transfer the transfer amount written in the bill without forcing a user to input the transfer amount.

Further, although in the above-described embodiment, the description is given of the configuration in which 7 is used as an example of the same number of digits as the account number, the number of digits to be used is not limited to 7. For example, the number of digits not smaller than 5 may be used as the same number of digits as the account number.

Further, although in the above-described embodiment, the description is given of the case where money is transferred to an account of a bank by way of example, the present invention may be applied to a case where money is transferred to an account of a financial institution other than banks, such as a post office in Japan.

Note that in the present embodiment, the processing for acquiring the transfer destination information may be performed by an apparatus other than the image forming apparatus 101. For example, the image forming apparatus 101 transmits image data of a bill to a server storing a program for realizing one or more functions of the above-described embodiment via a network or via a storage medium. This server acquires the transfer destination information and the transfer amount from the received image data and transmits these information items to the image forming apparatus 101.

Further, in the present embodiment, the transfer destination information included in image data of a bill may be acquired using a number having the same number of digits as a telephone number in place of a number having the same number of digits as an account number.

Note that although in the present embodiment, the image forming apparatus 101 is configured such that the one CPU 111 executes the above-described processes using one memory (RAM 113), another form may be employed. For example, the above-described processes can be executed by causing a plurality of CPUs, RAMs, ROMs, and storages to cooperate.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-024736 filed Feb. 21, 2022, which is hereby incorporated by reference herein in its entirety.

What is claimed is:

1. An image processing apparatus that communicates with a server which provides a transfer service, comprising:
at least one processor; and
a memory coupled to the at least one processor, the memory having instructions that, when executed by the processor, perform the operations as:
a reading unit configured to read an original on which a transfer destination is written and generate image data of the original;
an extraction unit configured to extract a number having a predetermined number of digits by performing optical character recognition on the image data;
a storage unit configured to store the number and position information of the number in the image data;
an acquisition unit configured to acquire information on the transfer destination, which is included in the image data, based on the number and the position information of the number; and
a transmission control unit configured to perform control to transmit a transfer instruction notification including the information on the transfer destination to the server.

2. The image processing apparatus according to claim 1, wherein the predetermined number of digits is the same number of digits as an account number.

3. The image processing apparatus according to claim 1, further comprising a display unit configured to display a confirmation screen including the information on the transfer destination, and
wherein when a user performs a predetermined operation as a transmission instruction on the confirmation screen, the transmission control unit performs control to transmit the transfer instruction notification to the server.

4. The image processing apparatus according to claim 3, wherein the instructions, when executed by the processor, perform the operations further as an instruction receiving unit configured to receive an instruction input to a screen displayed on the display unit, and
wherein the instruction receiving unit receives an instruction for changing information on a transfer destination displayed on the confirmation screen.

5. The image processing apparatus according to claim 1, wherein the information on the transfer destination includes a bank name, a branch office name, an account type, and an account number of the transfer destination.

6. The image processing apparatus according to claim 1, wherein the instructions, when executed by the processor, perform the operations further as a registration unit configured to register the information on the transfer destination included in the transfer instruction notification transmitted to the server, and position information in the information on the transfer destination in the image data.

7. The image processing apparatus according to claim 6, wherein the extraction unit extracts another number having the predetermined number of digits from other image data generated by the reading unit reading an original anew, and
wherein in a case where information on a transfer destination, including an account number matching the other number, has been registered, and position information of the other number matches position information of the account number, the transmission control unit performs control to transmit a transfer instruction notification including the information on the transfer destination to the server.

8. The image processing apparatus according to claim 7, wherein the transfer instruction notification includes a transfer amount selected by a user from a plurality of numbers extracted from the image data,
wherein the registration unit registers position information of the transfer amount in the image data in association with the information on the transfer destination, which is included in the transfer instruction notification transmitted to the server, and
wherein in a case where information on a transfer destination, which includes an account number matching the other number, has been registered, and position information of the other number matches position information of the account number, the transmission control unit performs control to transmit a transfer instruction notification including a number indicated by the position information of the transfer amount in the other image data, as a transfer amount, to the server.

9. The image processing apparatus according to claim 5, wherein the acquisition unit identifies a bank name of the transfer destination, which is included in the image data, based on a positional relationship between the number and a character string having “bank” at its end in the image data.

10. The image processing apparatus according to claim 5, wherein the acquisition unit identifies a branch office name of the transfer destination, which is included in the image data, based on a positional relationship between the number and a character string having “branch office” or “head office” at its end in the image data.

11. The image processing apparatus according to claim 5, wherein the acquisition unit identifies an account type of the transfer destination, which is included in the image data, based on a positional relationship between the number and a predetermined character string indicating an account type in the image data.

12. A method of controlling an image processing apparatus that communicates with a server which provides a transfer service, comprising:
reading an original on which a transfer destination is written and generating image data of the original;
extracting a number having a predetermined number of digits by performing optical character recognition on the image data;
storing the number and position information of the number in the image data;
acquiring information on the transfer destination, which is included in the image data, based on the number and the position information of the number; and
performing control to transmit a transfer instruction notification including the information on the transfer destination to the server.

13. A non-transitory computer-readable storage medium storing a program for causing a computer to execute a method of controlling an image processing apparatus that communicates with a server which provides a transfer service,
wherein the method comprises:
reading an original on which a transfer destination is written and generating image data of the original;
extracting a number having a predetermined number of digits by performing optical character recognition on the image data;
storing the number and position information of the number in the image data;
acquiring information on the transfer destination, which is included in the image data, based on the number and the position information of the number; and
performing control to transmit a transfer instruction notification including the information on the transfer destination to the server.
